(19) United States
(12) Patent Application Publication
(10) Pub. No.: US 2009/0314849 A1
(43) Pub. Date: Dec. 24, 2009

(54) AEROSOL DISPENSING APPARATUS

(76) Inventors: Colin Litten-Brown, Bracknell Berkshire (GB); Guy Edward Naishi, Bicester Oxfordshire (GB); Kishen Gohil, Surrey (GB)

Correspondence Address: CURATOLO SIDOTI CO., LPA, 24500 CENTER RIDGE ROAD, SUITE 280, CLEVELAND, OH, 44145, US

(21) Appl. No.: 12/438,689

(22) PCT Filed: Sep. 21, 2007
(86) PCT No.: PCT/CH2007/000467

§ 371 Date: Feb. 24, 2009

(30) Foreign Application Priority Data
Sep. 26, 2006 (GB) 0618859.3

(51) Int. Cl. B65D 83/14; B05B 11/00

(52) U.S. Cl. 239/1; 239/373

(57) ABSTRACT

An apparatus adapted to spray into an atmosphere a volatile liquid, the apparatus comprising an aerosol container (12) comprising a liquid-containing vessel with spray-actuating button (11), the aerosol container being fixed to the apparatus by means of a resilient support member (15,16) integral with the container, the container having a rest position, in which the button is in a non-depressed position in relation to a pressure pad (10) fixed within the apparatus, and a spray position, in which the button is in spray-actuating contact with the pressure pad against the resilience of the resilient member seeking to maintain the rest position.

The apparatus is simple to construct and operate, and may be constructed such that only appropriate refills can be used.

This invention relates to the dissemination of volatile liquids into an atmosphere by means of an aerosol and to apparatus for disseminating such liquids.

Aerosol-based apparatus for disseminating volatile liquids, typically fragrances for air freshening, but also other liquids such as medicinal and pesticidal formulations, are very well known in the art and many such devices are commercially available. There has been interest in such apparatus that function automatically, that is, the aerosol is actuated without direct human agency, usually according to a desired timing. To date, such apparatus have involved mechanical actuation, usually by means of cams, levers, gears and the like. It is desired that such apparatus be easy to maintain and replace, and this has generally be done by making the apparatus refillable, that is, the liquid is housed in an aerosol container with the appropriate valve, nozzle and pressurised propellant, and this container may be easily removed and replaced.

The problem with the use of such standard containers is that it is easy to put in an inappropriate container. In extreme cases, a container with an entirely inappropriate substance may be mistakenly inserted into such an apparatus, and the person inserting it may be oblivious of the mistake because the container fits without any problem, giving the impression that it is the correct one.

It has now been found that this problem may be completely overcome by means of a particular construction of aerosol utilising apparatus. The invention therefore provides an apparatus adapted to spray into an atmosphere a volatile liquid, the apparatus comprising an aerosol container comprising a liquid-containing vessel with spray-actuating button, the aerosol container being fixed to the apparatus by means of a resilient support member integral with the container, the container having a rest position, in which the button is in a non-depressed position in relation to a pressure pad fixed within the apparatus, and a spray position, in which the button is in spray-actuating contact with the pressure pad against the resilience of the resilient member seeking to maintain the rest position.

The invention further provides a method of releasing a volatile liquid into an atmosphere from an aerosol container, comprising
(a) providing on the container an integral, resilient support member having a rest position in which an aerosol-releasing button is not in aerosol-releasing contact with a fixed pressure pad; and
(b) causing the button to come into aerosol-releasing contact with the pressure pad against the resilience of the resilient support member.

The central feature of this invention is the provision of a unique aerosol container, one that comprises an integral resilient support member. What is meant by these terms is as follows; the natures of the entities involved will be hereinafter more fully described:
“Support member”—a member that allows the aerosol container to be fitted and held appropriately within an apparatus;
“integral”—container and support member are a single body and not two separate entities that can be relatively easily separated;
“Resilient”—the support member is capable of deflection from a rest position and will return to this rest position when a force causing deflection is removed.

Apart from having an integral resilient support member, the aerosol container for use in this invention is substantially identical to any other such container, in having the normal elements, namely a pressure vessel for the containing of volatile liquid and propellant, a valve with associated spray nozzle and a button, the depression of which will actuate the valve and cause the release of aerosol spray. For example, it may be a conventional aerosol dispenser equipped with an appropriate integral support member. However, in some particular cases it may be smaller, allowing for a more compact apparatus size and/or the utilisation of more than one aerosol container.

The support member is any member that will permit the aerosol container to be fitted and held within an apparatus. The precise nature of the support member will depend on the nature of the apparatus itself, and the skilled person will be able to envisage many possibilities. For example, the support member and container may be configured such that the two form a single unit that may be fitted into a matching receptable within the apparatus. It may be held in place by any convenient means, such as snap-fitting, bolting, screwing or by simply being held in place by an external apparatus cover being fitted over it. At this point, it should be noted that the ensemble of container and support member may comprise more than one container, and that the use of plural containers is included by the use of the singular “container”. Such a possibility is of particular interest at the moment, as there is interest in, for example, air fresheners that can emit a variety of fragrances, rather than just one. Particular embodiments of this concept will be considered in more detail hereinunder.

The support member may be integral by its being formed as a single unit with the container, or it may be a separate unit that is fixed to the container by any suitable means. For example, the container may be a conventional metal aerosol container and the support member a frame of a different material into which the vessel is fitted and retained by, for example, adhesive, welding, crimping, screwing, bolting and snap fitting.

The requirement for resilience may be achieved by any convenient means. For example, the support may be made of a material that is inherently resilient, such as a spring or an elastomeric material. It is also possible to achieve the necessary resilience by means of a support system involving pivoted, rigid arms and springs, but making the support system of a resilient material has the advantages of simplicity of manufacture and reliability in use.

The apparatus may utilise standard aerosol containers, which are attached to the resilient means by any convenient method, for example, screwing, bolting and snap-fitting, as described hereinabove. However, the aerosol container may also come with the resilient means already built in and adapted to be fitted to the apparatus.

Thus, in another aspect of the invention, there is provided a refill for an apparatus adapted to dispense a volatile liquid in an atmosphere by means of aerosol spray, the refill comprising at least one pressurised aerosol container which comprises an integral, resilient support member adapted to be deflected from a rest position to a liquid-dispensing position by an applied force and to return to the rest position when the force is removed.

Such an arrangement has the advantage that it is impossible to fit an inappropriate container into the apparatus—only a container that has the appropriate integral resilient support member will fit.

Although “aerosol container” has been mentioned in the singular, the invention also includes the possibility of there being more than one aerosol container, and this is comprehended by the use of the singular. In a particular embodiment, a refill comprises two aerosol containers with an integral support member of resilient plastics material.

The aerosol dispensing is achieved by the deflection of the container from a rest position to a position in which an aerosol-releasing button is pressed against a fixed pressure pad in an apparatus. The pressure pad may be, for example, a simple projection attached to or moulded into a housing or other component of the apparatus. The force deflecting the container into contact with the pressure pad may be any suitable means, and the skilled person will be able to conceive of many suitable means. The means may be mechanical, electric, pneumatic or hydraulic, or a combination of those things. The actual movement may be achieved by the use of, for example, pushrods, cams and levers. Specific examples include solenoids and cams rotated by electric motors with, where necessary, suitable reduction gearing. All of these things are simple, reliable off-the-shelf components readily available to the skilled person.

In a particular embodiment, the one in which two or more aerosols are involved, the deflection may be achieved by means of a rocking lever that may be caused to move in either direction and therefore to exert deflecting pressure on one of two containers. The directional movement is easily achieved by standard electronic components. In addition, there can be built into such apparatus a timing function, so that the duration and nature of the aerosol spray may be predetermined. More commonly, the aerosols used have a metered-dose mechanism in the valve such that, on a single activation only, a pre-set amount of product is dispensed. In such a case, the timing function would be set just sufficiently to activate this dose, and any prolonged pressure would not result in further product being dispensed. By metering the aerosol, the mechanism for activating can be simpler as the timing does not have to be so accurate on the mechanism.

As mentioned hereinabove, the apparatus according to this invention may be made simply from known raw materials. They are reliable, robust and versatile in use.

The invention is now further described with reference to the drawings, which depict preferred embodiments and which are not intended to be in any way limiting on the scope of the invention.

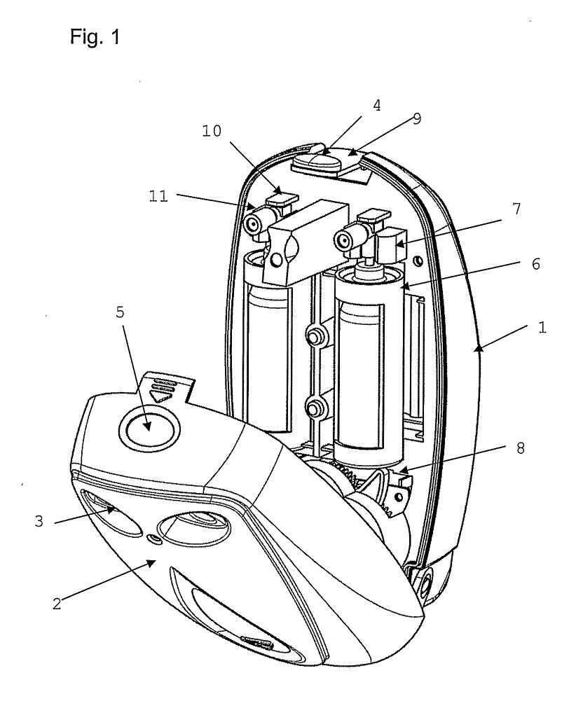

FIG. 1 is a perspective view of an embodiment (an air freshener) with two fragrances.

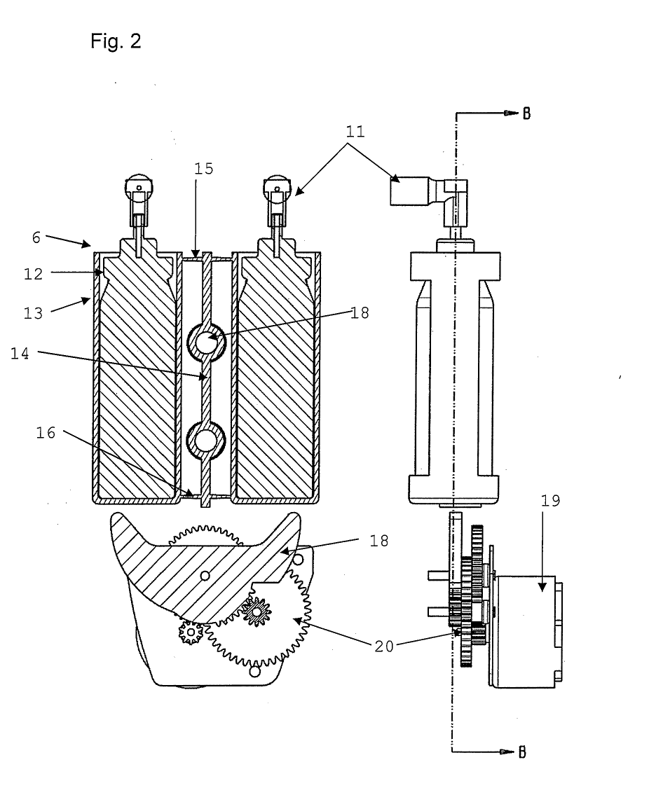

FIG. 2 is, on the right, a schematic end-elevation of a refill unit for use in the embodiment of FIG. 1, along with the operating mechanism, and on the left a schematic vertical part-cross-section of the end-elevation along the axis BB.

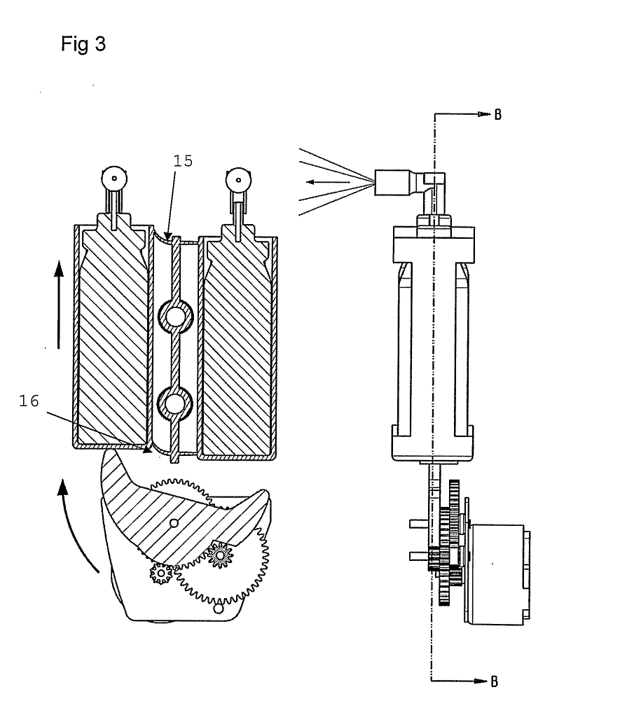

FIG. 3 is a reproduction of FIG. 2, showing the apparatus in operation.

In FIG. 1, an air freshener comprises a casing 1 with a hinged cover 2, both being moulded from a rigid plastics material. Formed in this cover are two ports 3, which are the exit ports for two aerosol sprays, which shall later be described. The cover is held in place by a push button 4 which locates in a corresponding hole 5 in the top of the cover. Within the enclosure formed by the casing and lid are an aerosol unit 6 held in place by snap fittings 7 moulded within the casing, and a drive unit 8. The push button is mounted on a projection 9 in the casing. There are also provided in the casing two projections 10, these being positioned directly over individual valve/nozzle units 11 of the aerosol containers. Their function will be further described hereinunder.

FIG. 2 shows the aerosol unit and the drive unit in more detail.

The aerosol unit 6 comprises two aerosol containers 12. These are seated within essentially cylindrical holders 13, which holders are joined by a framework. This framework comprises a central locating member 14 from which extend to each of the holders a pair of resilient arms 15 and 16. The aerosol containers 12, the holders 13 and the framework 14-16 form an integral unit that can be fitted into the casing 1. The central locating member 14 comprises a pair of moulded cylinders 17, which slide over corresponding projections moulded in the casing 1, and these and the snap fittings 7 hold the aerosol unit in place in the casing.

The operating unit comprises a double cam profile 18 driven by an electric motor 19 via a reduction gear train 20. One cam profile is positioned under each of the holders 13, such that, when the motor is suitable actuated, a cam profile will contact the adjacent holder and push it upwards. The electric motor 19 can rotate in either direction and its direction and extent of movement are governed by an electronics package (not shown).

FIG. 3 depicts the apparatus in operation. An appropriate signal to the motor 19 causes it to turn, and this is transmitted via the reduction gear train 20 to the double cam profile 18. This turns, pushing the holder 13 and its associated container 12 upwards against the resilience of the arms 15, 16 until the valve/nozzle unit 11 meets the projection 10. This depresses the valve/nozzle unit, thus causing the aerosol to spray liquid into the atmosphere. The length of time for which the container is held in this open position is regulated by the electronics package associated with the motor. At a desired time, the motor reverses direction and the double cam profile moves away from the holder 13, thus allowing the resilience of the arms 15, 16 to restore the container 12 and holder 13 to the rest position. Depending on what is desired, the motor can then stop, leaving both containers in the rest position, or it can rotate the double cam profile into contact with the other container/holder, either immediately, or at some desired time in the future.

The skilled person will realise that there are many variations and modifications of this invention that are not described here, but which fall within the scope of the invention. For example, the mechanism can be independently programmed for other sequences. In one embodiment, the two aerosols are of different volume and the larger aerosol is used on a regular basis but the smaller aerosol is used periodically, for example to dispense a malodour counteractant or other active material in response to a particular need. It may also contain a complementary fragrance to a fragrance contained in the larger aerosol. In such a case, the user may have a “boost” button that would allow the user to activate the second aerosol either to dispense active material in response to a particular need or to boost the fragrance output of the main aerosol as desired.

1. An apparatus adapted to spray into an atmosphere a volatile liquid, the apparatus comprising an aerosol container comprising a liquid-containing vessel with spray-actuating button, the aerosol container being fixed to the apparatus by means of a resilient support member integral with the container, the container having a rest position, in which the button is in a non-depressed position in relation to a pressure pad fixed within the apparatus, and a spray position, in which the button is in spray-actuating contact with the pressure pad against the resilience of the resilient member seeking to maintain the rest position.

2. An apparatus according to claim 1, in which the support member and container are configured such that they form a single unit that may be fitted into a matching receptacle within the apparatus.

3. An apparatus according to claim 1, in which the support member is made of material that is inherently resilient.

4. A refill for an apparatus according to claim 3, comprising at least one pressurised aerosol container which comprises an integral, resilient support member adapted to be deflected from a rest position to a liquid-dispensing position by an applied force and to return to the rest position when the force is removed.

5. A refill according to claim 4, comprising two aerosol containers.

6. An apparatus according to claim 3, comprising two aerosol containers, the spray-activating means comprises a rocking lever capable of exerting spray-actuating pressure on one container at a time.

7. An apparatus according to claim 1, comprising a timing function that permits the duration and nature of the aerosol spray to be predetermined.

8. An apparatus according to claim 1, in which the aerosol has a metered dose mechanism, such that, for each activation, only a predetermined dose is released.

9. A method of releasing a volatile liquid into an atmosphere from an aerosol container, comprising
(a) providing on the container an integral, resilient support member having a rest position in which an aerosol-releasing button is not in aerosol-releasing contact with a fixed pressure pad; and
(b) causing the button to come into aerosol-releasing contact with the pressure pad against the resilience of the resilient support member.

10. A method according to claim 9 in which there are two containers, the force being provided by a rocking lever that exerts pressure on one container at a time, causing the button thereof to come into aerosol-releasing contact with the pressure pad.
